(19) United States
(12) Patent Application Publication
(10) Pub. No.: US 2002/0021084 A1
(43) Pub. Date: Feb. 21, 2002

(54) ELECTROLUMINESCENT ELEMENT HAVING ELASTIC CONDUCTIVE PROJECTION ON ELECTRODE CONNECTION PORTION

(76) Inventor: KOJI YONEDA, TOKYO (JP)

Correspondence Address: JOEL E. LUTZKER, ESQ., SCHULTE ROTH & ZABEL LLP, 919 THIRD AVENUE, NEW YORK, NY, 10022, US

(21) Appl. No.: 09/181,285

(22) Filed: Oct. 28, 1998

(30) Foreign Application Priority Data
Oct. 29, 1997 (JP) 297 491/97

(51) Int. Cl. H01J 1/62

(52) U.S. Cl. 313/498

(57) ABSTRACT

An electroluminescent element is provided that is easily mounted on a circuit board. A transparent film 1 is provided of polyethylene terephthalate (PET) at an extreme front surface thereof. On a rear surface of the transparent film, indium tin oxide (ITO) is vapor deposited to form a transparent electrode 2. On a rear surface of the transparent electrode, an luminescent layer 3 is formed. On a rear surface of the luminescent layer, an insulating layer 4 is formed, and on a rear surface of the insulating layer, a rear electrode 5 is formed. On a rear surface of the rear electrode 5, a connection electrode portion 6 for the electroluminescent element is formed in an exposed state and a protecting layer 7 is formed on the remainder of the rear surface of the rear electrode 5. The transparent electrode 2 at one part projects beyond the luminescent layer 3 to provide a connection electrode portion 8 for the electroluminescent element wherein a conductive layer 9 is formed on a rear surface of the transparent electrode 2. Projections 10 and 11 are formed of an elastic conductive resin projecting from the rear surfaces of the conduction electrode portions 6 and 8. When mounting the electroluminescent element on a circuit board 13, connection with electrode portions on the circuit board is made by compressing these projections into a compressed state.

### BACKGROUND OF THE INVENTION

1. Field of the Invention

The present invention relates to an electroluminescent element.

2. Description of the Prior Art

The structure of an electroluminescent element has a combination of various constituent elements: electrodes, an insulating layer and a luminescent layer, the basic principle of operation is that alternating current is applied between the electrodes, with an insulating layer and a luminescent layer that causes electroluminescence interposed between the electrodes. Mounting such an electroluminescent element on a circuit board is accomplished by soldering metal leads between electrode connecting portions on the electroluminescent element and electrodes on a circuit board. Alternatively, the electrode connecting portions of the electroluminescent element are connected to the electrodes of the circuit board by pressure contact through the use of a spring, rubber contact, or other parts. Additionally, connection can be effected by soldering through a flexible printed circuit (FPC) or a flexible film circuit (FFC) or by the use of connectors including FPCs and FFCs..

It is troublesome, however, when mounting an electroluminescent element on a circuit board in manufacturing operations to perform soldering or other connecting processes using metal leads, connectors, FPCs, FFCs or other devices, as stated above. The problem arises with respect to reducing process time because it is impossible to effectively implement so-called surface mounting that includes the processes of placing an electroluminescent element directly on a circuit board, applying solder paste and then heating for reflow soldering (as performed for other circuit elements, for example, a bare chip capacitor or the like). Additionally, a large number of parts such as springs is cumbersome.

### SUMMARY OF THE INVENTION

In order to solve the above stated problem, the electroluminescent element of the present invention is provided with elastic conductive projections at the connection electrode portions. These projections are of an elastic conductive resin, or other conductive deformable material, and which are capable of being more easily mounted on a circuit board. These projections can be formed by a common process similar to a process of laminate-forming. The process consists of laminate-forming, in order, the layers for an electroluminescent element by a process of screen printing or similar deposition process. When the present electroluminescent element is mounted on a circuit board, it can be placed directly on the circuit board and joined thereto in a compressed state, thereby achieving connection with a favorable conductive state. The process is simple and quick.

### BRIEF DESCRIPTION OF THE DRAWINGS

FIG. 1 is a sectional view of an electroluminescent element according to one embodiment of the present invention.

### DETAILED DESCRIPTION OF THE INVENTION

In an electroluminescent element having an insulating layer and an luminescent layer formed between a transparent front electrode and a rear electrode, electroluminescence of the luminescent layer is caused by applying an alternating current between the respective electrodes. The electroluminescent element of the present invention is characterized in that the respective electrodes have connection electrode portions provided with projections of an elastic conductive resin.

The provision of the projections at the connection portions of the respective electrodes provides positive conduction by connecting the connection electrode portions on the electroluminescent element in a compressed state to electrode portions on the circuit board, when the electroluminescent element is mounted on the circuit board.

Embodiment

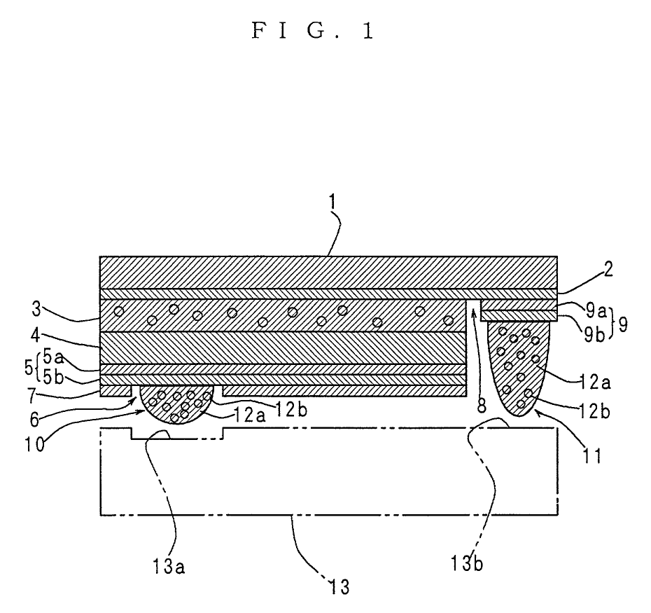

Now an embodiment will be explained with reference to the drawings. FIG. 1 illustrates a sectional view of an electroluminescent element having constituent layers which will be explained in order from a front side to a rear side. On an extreme front of the electroluminescent element (the upper side of FIG. 1), there is provided a transparent film 1 such as of polyethylene terephthalate (PET). On a rear side of the transparent film 1, a transparent electrode 2 is formed by vapor-depositing indium tin oxide (ITO). On a rear surface of the transparent electrode 2, a luminescent layer 3 is formed. The luminescent layer 3 is formed by screen-printing using a paste of powders of zinc sulfide (ZnS) and copper (Cu) as luminescent materials kneaded with a binder. An insulating layer 4 is formed on a rear surface of the luminescent layer 3. The insulating layer 4 is formed similarly by screen-printing using a paste of a material such as barium titanate (BaTiO₃) kneaded with a binder. Further, a rear electrode 5 is formed on a rear surface of the insulating layer 4. The rear electrode 5 is formed by two layers, 5a and 5b. Layer 5a is similarly formed by screen-printing using a paste of a carbon power kneaded with a binder and layer 5b is formed using a silver paste. This layering prevents electrical charges from concentrating at the connection electrode portion 6 of the luminescent layer 3 when electrical voltage is applied to the electroluminescent element. The presence of the silver layer 5b with low electrical resistance relative to comparatively high electrical resistance of the carbon layer 5a , eliminates deviated distribution of electrical charges, thus enabling application of electrical voltage evenly throughout an entire luminescent layer 3.

The rear electrode 5 has an area designated a connection electrode portion 6 at which the layer 5b is left exposed. Also, a connection electrode portion 8 is provided by projecting a part of the transparent electrode 2. At the connection electrode portion 8 on a rear surface of the transparent electrode 2, a conductive layer 9 is formed by two layers, a layer 9a is applied by screen-printing using a paste of a carbon powder kneaded with a binder and a layer 9b is applied using a silver paste. A protecting layer 7 is formed over the entire rear surface of the electroluminescent element excepting the area of the connection electrode portions 6 and 8 in order to prevent moisture from intruding to the luminescent layer 3.

At the connection electrode portions 6 and 8, projections 10 and 11 are formed, respectively, projecting in bump form from the rear surfaces of the exposed layers 5b and 9b. These projections, 10 and 11, are of an elastic conductive resin or similar deformable conductive material. These projections are formed projecting in a semicircular or semielliptical shape by screen-printing using an elastic conductive resin ink of rubber, vinyl resin or similar conductive deformable material 12a with conductive particles 12b such as silver or carbon dispersed therein. The projections, 10 and 11, are required to have such heights that they project from the rear surface of the protecting layer 7. As will be explained, when the electroluminescent element is mounted on a circuit board 13, these projections are compressed to enable stable voltage supply to the luminescent layer 3. It is preferred that the projections are of heights such that they are compressed to, for example, approximately 0.2-0.3 mm. If the height in the compressed state is low, conduction will be unstable. On the other hand, if the height in the compressed state is too high, the projection 10 is excessively compressed during mounting the electroluminescent element and thus exerts pressure on the luminescent layer 3 and the insulating layer 4, resulting in the possibility of crushing these layers. This might cause a lighting failure or shortcircuit.

The electroluminescent element of the present invention is structured as explained above. When manufacturing the electroluminescent element, a transparent electrode 2, a luminescent layer 3 and an insulating layer 4 are formed by screen printing, in that order, on a transparent film 1. Then, a layer 5a of the rear electrode 5 and a layer 9a of a conductive layer 9 are simultaneously formed by screen printing. Subsequently, a layer 5b of the rear electrode 5 and a layer 9b of the conductive layer 9 are simultaneously formed by screen printing. A protecting layer 7 is then formed by screen printing on an entire rear surface of the electroluminescent element excepting the areas of connection electrode portions 6 and 8. Finally, projections 10 and 11 are simultaneously formed by screen printing, thus completing the manufacture.

To mount the electroluminescent element thus manufactured onto a circuit board 13, the projections 10 and 11 are positioned adjacent the corresponding electrode portions 13a and 13b on the circuit board. The electroluminescent element is then joined to the circuit board by depressing it onto the circuit board to compress the projections 10 and 11 into a compression state for subsequent heating. In this manner, the electroluminescent element of the present invention can be surface-mounted on a circuit board 13 in a manner similar to surface-mounting of other circuit elements which are not shown.

Because the present invention is provided with projections formed projecting from connection electrode portions, when mounting an electroluminescent element on a circuit board, positive conduction is obtained merely by connecting, in a depression state, the projections to electrode portions on the circuit board, thus enabling simple connection operations in a brief time. Also, since parts such as springs are not required, the total number of parts is reduced with reduced cost. Also, because the formation of the projections can be formed subsequent to and complementary with a series of processes for manufacturing the electrolumninescent element, the manufacture of such electroluminescent elements is easy to perform.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

What is claimed is:

1. An electroluminescent element comprising:
a front electrode and a rear electrode;
a luminescent layer between said front and rear electrodes;
an electrode connection portion of at least one of said front and rear electrodes; and
an elastic conductive projection formed on said electrode connection portion.

2. The electroluminescent element according to claim 1, wherein said projection is made of a resin.
